(19) United States
(12) Patent Application Publication
(10) Pub. No.: US 2009/0030801 A1
(43) Pub. Date: Jan. 29, 2009

(54) Permissive search intent registry

(76) Inventor: Anthony Meggs, Rockledge, FL (US)

Correspondence Address: HAYWORTH, CHANEY & THOMAS, P.A., 202 N. HARBOR CITY BLVD., SUITE 300, MELBOURNE, FL, 32935, US

(21) Appl. No.: 12/231,187

(22) Filed: Aug. 29, 2008

Related U.S. Application Data
(63) Continuation-in-part of application No. 11/267,210, filed on Nov. 7, 2005.
(60) Provisional application No. 60/966,571, filed on Aug. 29, 2007.
(60) Provisional application No. 60/966,755, filed on Aug. 29, 2007.

(51) Int. Cl. G06Q 30/00; G06F 17/30

(52) U.S. Cl. 705/14; 707/3

(57) ABSTRACT

A permissive search intent registry allowing intending purchasers to receive special offers and incentives from participating merchants wherein merchants may thereby more effectively target advertising campaigns by gaining access to a pool of intending purchasers, allowing merchants to differentiate between intending purchasers and mere “click-thrus”. An intending purchaser may tag a search, product, or category of products as being related to a purchase intention and thereby automatically be linked to participating merchants via the present invention. Intending purchasers are rewarded for the disclosure regarding their purchase intent and their estimated purchase timeline by receiving special offers, rewards, and/or incentives from the participating merchants that are not readily available to the general public. In this manner, both the purchasers and the merchants receive a benefit through their automatic relationship via the present invention; purchasers receive rewards towards the desired goods or services and merchants may directly market to intending purchasers.

### CROSS REFERENCE TO RELATED APPLICATIONS

This application is a continuation-in-part of both Ser. No. 11/267,210, filed with the USPTO on Nov. 7, 2005, and Ser. No. 11/708,587, filed with the USPTO on Feb. 21, 2007, which are both herein incorporated by reference in their entirety. This application also claims the benefit of provisional patent application Ser. No. 60/966,571, filed with the USPTO on Aug. 29, 2007, and provisional patent application Ser. No. 60/966,755, filed with the USPTO on Aug. 29, 2007, which are both herein incorporated by reference in their entirety.

### STATEMENT REGARDING FEDERALLY SPONSORED RESEARCH OR DEVELOPMENT

Not applicable.

### INCORPORATION-BY-REFERENCE OF MATERIAL SUBMITTED ON A COMPACT DISK

Not applicable.

### BACKGROUND OF THE INVENTION

1. Field of the Invention

The present invention generally relates to a system and method for locating intending purchasers to be used as targets of direct marketing, incentives, and/or other promotions. More particularly, the present invention relates to an Internet-based system and method for identifying future intent purchasers and linking such purchasers with providers of the desired goods or services.

2. Background Art

Direct marketing is an efficient method of selling that was introduced in the 1960's to take advantage of developments in automation and the study of advertising. Rather than advertise to the general population, marketing efforts are focused on those most likely to purchase, leading to much more cost-effective sales techniques. Based on scientific advertising principles, direct marketing is serviced by increasingly more automated warehousing, shipping, and collection techniques. The phrase was coined in 1961 by Lester Wunderman, commonly regarded as the father of the direct marketing field.

As stated by Wunderman, direct marketing is only effective when certain conditions are met. A prospect must have the ability, willingness, and readiness to buy before a direct sale can be consummated. These three conditions are illustrated using a traditional concept in sales and marketing, the sales funnel 100, illustrated in FIG. 1. Marketers attempt to develop an ideal customer profile and suitable means for communicating with the ideal audience, such as direct mail, telephone solicitations, advertising in trade publications, trade shows, seminars, or on the Internet. Those likely to be interested in a given product or service are termed suspects. Suspects that express an interest in the offer, i.e. a willingness to purchase, are known as prospects. Those prospects with the financial ability to purchase are called qualified prospects. Intending purchasers are qualified prospects that are ready to purchase in the near future, and it is from the intending purchasers that customers are finally generated. Of course, the sales funnel 100 is a broad concept, and the order in which the three conditions (ability, willingness, and readiness) are applied to narrow the pool of suspects may be rearranged. The basic principle of the sales funnel 100 is that a more efficient movement down the funnel leads to a decreased marketing and sales cost per each eventual purchase.

To date, most direct marketing work aims to ascertain the ability to pay, or the qualified prospects. It is relatively straightforward to use demographic or lifestyle data available from third party data enhancement services, such as household income, to determine a suspect or prospect's ability to pay. However, such data provides little information on willingness or readiness to purchase. Such limitations have been addressed by predictive modeling or surveys of buying intentions. Predictive modeling is a statistical technique that uses various attributes about a prospect to assess a likelihood of buying. These attributes include actual or predicted behavior, attitude as determined from surveys, and collected or overlaid demographic data. Those believed to be unlikely buyers are excluded from costly direct marketing programs, while the most likely buyers are the subjects of intense marketing efforts. Predictive modeling provides the advantages of low cost and scalability.

One disadvantage of predictive models is that they may miss key attributes and incorporate stale data. For example, predictive models are often used for predicting purchases of high-ticket items, such as automobiles. However, the intention to buy a new car is often known only after the fact, when new vehicle registration information is available. What is needed is a reliable leading indicator of buying intent. Surveying has been considered the standard for identifying intending purchaser leads (i.e. consumers with a stated intention of buying a particular class of product or service within a given time frame). Surveys include questions that assess buying intentions, for example, “Do you plan to buy a new car in the next six months?” The self-reported data is then used to identify intending purchaser leads. A significant problem with surveys is that they are inefficient, as measured by the response rate, and expensive, as measured by the cost per completed survey.

Both predictive models and surveys also suffer from a delay between lead generation and distribution to a sales force for pursuit. Even if the leads are of high quality, by the time that they can be distributed using traditional methods, the leads are no longer “hot,” i.e. the intended purchase has already been completed.

With the rapid growth of the World Wide Web in recent years, a large amount of effort has been devoted to using the Internet for advertising and for collecting marketing and demographic data. When a consumer accesses a web site, the web server often sends a cookie along with the requested page. The cookie is a text string that may be saved to the user's hard drive, and is then read by the web server when the user accesses the same site. The cookie can be used to record user preferences or browsing history. Many web sites have banner ads along the top of the page that are provided directly by an advertising company, which sends a cookie along with the banner ad. Advertising companies use cookies to determine what advertisements the user has already seen, so that the same advertisement is not displayed twice, and also to track the user's browsing history, a potentially useful indicator of the user's interests. Before sending a banner ad to a user, the cookie is read to determine the most effective advertisement to send.

Direct marketers have long collected databases of lifestyle data of people, such as household income, number of children in the family, and hobbies and interests. Examples include Polk's Lifestyle Selector, Acxiom's Infobase, or Metromail/Experian's INSOURCE. Now that online behavior can be tracked, and often linked to a person's name, home address, and telephone number, databases containing both online and offline behavior data are being collected. Such information gives direct marketers a rich picture of a user, as well as a variety of means to target consumers, including mail, telephone, email, and online ads. While the information that is currently gathered is useful for profiling consumers, it does not address the problem of generating intending purchaser leads. That is, the information does not indicate buying intent, but rather records past purchases and behavior. Similarly, the information used to determine which online advertisement to send is based on past behavior and interests, and is not based on indicators of future purchases.

Typical marketers suffer from improper targeting of their advertisements, promotions, and incentives. If marketers would have a better way of identifying those future intending purchasers with a high purchase propensity for their products and direct ads, promotions, and incentives only at them, these promotions would be significantly more lucrative. Marketers might fight for these good customer leads with better introductory prices and other promotions, as well as with better products and better service. They might also be willing to pay or otherwise reward these customers for the right to advertise to them. A marketer who can direct her customer acquisition efforts at those future intending purchasers can afford to divert resources from less efficient and less targeted advertising channels.

The present invention relates in general to a system and method of identifying future intending purchasers for direct marketing campaigns such as advertising, promotions and incentives and thereby increasing the rate of return on the investment from participating in such direct marketing campaigns. Today, prior art customer lead generation is generally a database of customer names and addresses collected at trade shows through either solicitation or sweepstakes drawings. The collected names and addresses are then distributed to particular merchants and retailers in geographic areas coordinated with the customer lead's address. In general, there is no sorting or prioritizing of the customer leads based upon the customer lead's purchase interest or purchase horizon, and purchase intent is often merely inferred or extrapolated from the collected data. Consequently, wading through this vast prior art collection of names is time consuming and generally results in the loss of customers who were ready to purchase at the time of collecting their personal lead information based upon the delay in subsequent contact with the customer lead. This loss of customer leads also results in wasted time, effort and money by the marketers, as well as decreases the marketer's rate of return on investment in the marketing campaign.

The present invention allows for receipt of an affirmative confirmation of future purchase intent and an estimated purchase timeline directly from the intending purchasers, and the ability to collect such valuable data may be tied to offering responsive intending purchasers credit, promotions, incentives, and/or discounts from the participating merchants, wherein such rewards and incentives are not made available to the non-responding members of the general public. The system and method of the present invention may utilize a network such as the Internet to greatly facilitate the communication and display of participating merchant advertisements and/or other content to future intending purchasers upon the intending purchaser's affirmative confirmation of their purchase intent and/or other relevant information. When a user or intending purchaser of the present inventive system and method “tags” a specific product or search string via an affirmative confirmation, such a purchase intention may be broadcast to a plurality of participating merchants wherein these participating merchants may then compete for the business of the intending purchaser by offering special offers, promotions, discounts, and the like on the specific item or category of items of the purchase intent.

### BRIEF SUMMARY OF THE INVENTION

In accordance with one embodiment, a method of linking at least one intending purchaser with at least one participating merchant via an electronic network, the method comprising the steps of: querying the at least one intending purchaser to determine if an electronic network search is related to a purchase intention of the at least one intending purchaser; and receiving an affirmative confirmation from the at least one intending purchaser that the electronic network search is related to the purchase intention of the at least one intending purchaser. Alternate embodiments of the method of the present invention may independently further comprise the step(s) of: requesting an estimated purchase timeline from the at least one intending purchaser; receiving the estimated purchase timeline from the at least one intending purchaser; awarding at least one credit to the at least one intending purchaser in exchange for the affirmative confirmation; aggregating one or more of the electronic network searches within a first graphical user interface module allowing for subsequent review by the at least one intending purchaser; displaying information of the at least one participating merchant to the at least one intending purchaser via the electronic network when the electronic network search comprises at least one key word search term that correlates with at least one key word associated with products or services of the at least one participating merchant; and offering at least one reward from the at least one participating merchant to the at least one intending purchaser for incentivizing the at least one intending purchaser to transact with the at least one participating merchant regarding the purchase intention.

The present invention further comprises a system for linking at least one intending purchaser with at least one participating merchant via an electronic network, the system comprising: means for querying the at least one intending purchaser to determine if an electronic network search is related to a purchase intention of the at least one intending purchaser; and means for receiving an affirmative confirmation from the at least one intending purchaser that the electronic network search is related to the purchase intention of the at least one intending purchaser. Alternate embodiments of the system of the present invention may independently further comprise: means for requesting an estimated purchase timeline from said at least one intending purchaser; means for receiving the estimated purchase timeline from the at least one intending purchaser; means for awarding at least one credit to said at least one intending purchaser in exchange for said affirmative confirmation; means for aggregating one or more of the electronic network searches within a first graphical user interface module allowing for subsequent review by the at least one intending purchaser; means for displaying information of the at least one participating merchant to the at least one intending purchaser via the electronic network when the electronic network search comprises at least one key word search term that correlates with at least one key word associated with products or services of the at least one participating merchant; means for allowing at least one additional network system to access the at least one key word search term of the electronic network search of the at least one intending purchaser, wherein the at least one additional network alters at least one advertisement displayed thereon to correlate with the goods or the services pertaining to the electronic network search; and means for offering at least one reward from the at least one participating merchant to the at least one intending purchaser for incentivizing the at least one intending purchaser to transact with the at least one participating merchant regarding the purchase intention

The present invention is described in detail below with reference to the accompanying drawings.

### BRIEF DESCRIPTION OF THE DRAWINGS

FIG. 1 depicts a schematic diagram of a sales funnel as known in the prior art.

FIG. 2 depicts a block diagram of typical search engine technologies in accordance with the prior art.

FIG. 3 depicts an example illustrating which portions of a search result are noticed based on eye-tracking technologies in accordance with the prior art

FIG. 4 depicts a flow chart diagram of the method steps in an exemplary embodiment of the present invention.

FIG. 5 depicts a flow chart diagram of an embodiment of the present invention.

FIG. 6 depicts a flow chart diagram of an embodiment of the present invention.

FIG. 7 depicts a screen shot of an embodiment of the present invention.

FIG. 8 depicts another screen shot of an embodiment of the present invention.

FIG. 9 depicts another screen shot of an embodiment of the present invention.

FIG. 10 depicts another screen shot of an embodiment of the present invention.

FIG. 11 depicts a screen shot of an embodiment of a first graphical user interface module of the present invention.

FIG. 12 depicts a screen shot of an embodiment of both a first graphical user interface module and a second graphical user interface module of the present invention.

FIG. 13 depicts a magnified view of a screen shot of an embodiment of a second graphical user interface module of the present invention.

FIG. 14 depicts a magnified view of a screen shot of an embodiment of a second graphical user interface module of the present invention.

FIG. 15 depicts a magnified view of a screen shot of an embodiment of a second graphical user interface module of the present invention.

FIG. 16 depicts a magnified view of a screen shot of an embodiment of a second graphical user interface module of the present invention.

FIG. 17 depicts a magnified view of a screen shot of an embodiment of a second graphical user interface module of the present invention.

### DETAILED DESCRIPTION OF THE INVENTION

Although the following detailed description contains many specifics for the purposes of illustration, anyone of ordinary skill in the art will appreciate that many variations and alterations to the following details are within the scope of the invention. Accordingly, the following preferred embodiments of the invention are set forth without any loss of generality to, and without imposing limitations upon, the claimed invention.

The present invention may include various steps or means, which will be described below. The steps or means of the present invention may be performed by hardware components or may be embodied in machine-executable instructions, which may be used to cause a general-purpose or special-purpose processor or logic circuits programmed with the instructions to perform the steps or means. Alternatively, the steps or means may be performed by a combination of hardware and software.

It is appreciated that a lesser or more equipped computer system than the example described above may be desirable for certain implementations. Therefore, the configuration of computer system may vary from implementation to implementation depending upon numerous factors, such as price constraints, performance requirements, technological improvements, and/or other circumstances.

Current day search marketing methods involve displaying text advertisements along side natural search results that have been returned from a keyword search query. Text advertisements are sponsored and paid by merchants who wish to display specific advertisements that are relevant to the user's search query. Merchants pay the search engine sites every time a user clicks on a text advertisement. Unfortunately, these merchants are receiving and paying for clicks from users who may or may not have purchase intentions relevant to the merchant's product or services. Thus, a system and method that enables and incentivises a user to announce his or her purchase intentions when searching and surfing throughout the Internet or any other available network would allow merchants to intereact differently with those visitors who are more likely to be making a near-term purchase.

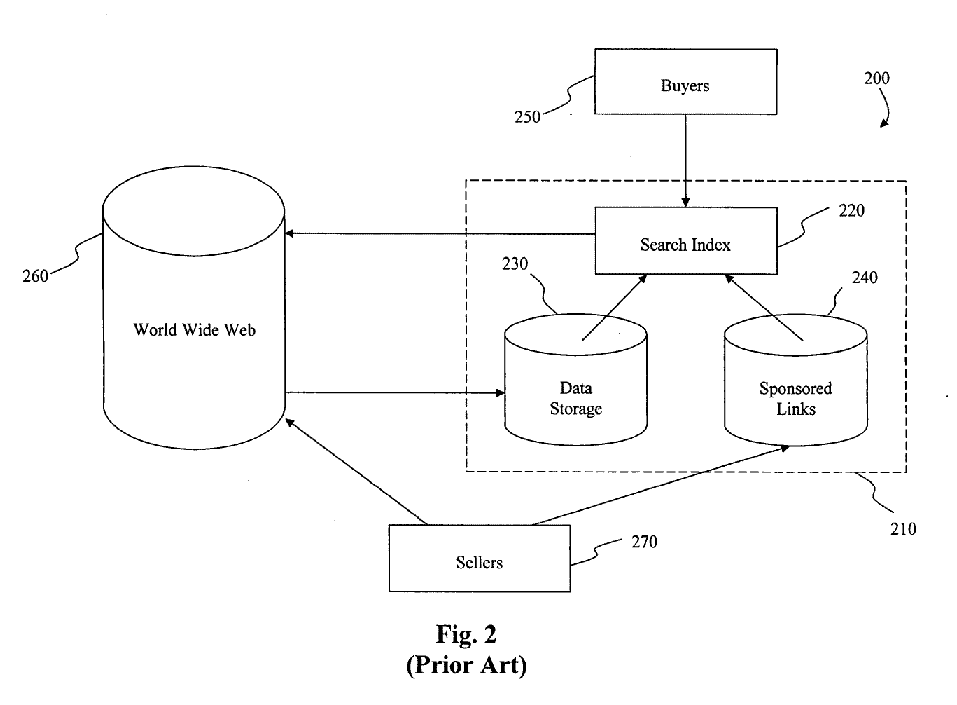

As shown in FIG. 2, typical search engine technologies 200 in accordance with the prior art use keyword search engines 210 include a keyword search index 220 communicably coupled to a data storage 230 and sponsored links 240. The keyword search index 220 is populated with terms used by buyers 250 when conducting a search. The keyword search engine 210 scours the Internet (World Wide Web) 260 for documents or web pages that contain the keywords. The documents, web pages, or relevant data to link or point to such documents and web pages are stored in data storage 230, which is used to further populate the keyword search index 220. The searching, storing, and selecting mechanisms are extremely complicated and require massive data storage and processing power. Sellers 270 typically purchase the option to have their sponsored links 240 included in the search results provided to buyers 250 based on various criteria. As a result, advertising drives current search engine technologies.

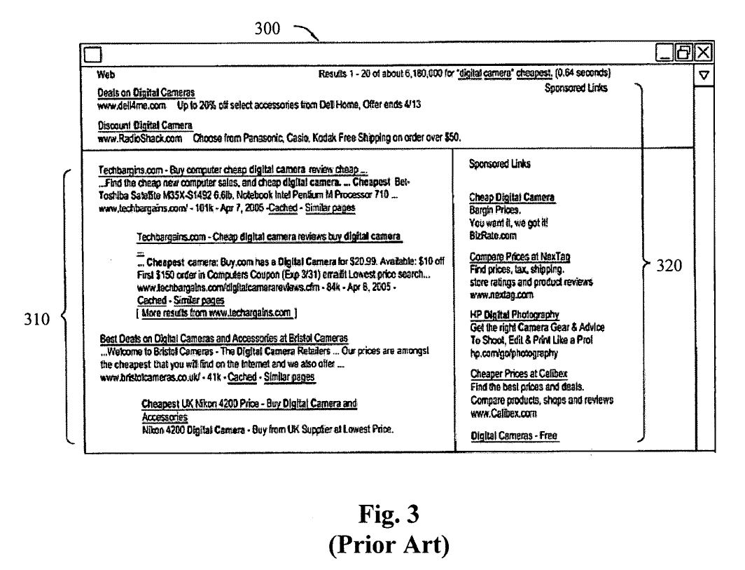

Current technologies do not respect the time of the consumer because the results are often not relevant. Clicking on a link often leads to more time searching a website. Current search engine technologies do not maximize the Internet's full potential because they do not give sellers proactive tools. They still have to wait for a buyer to click on a sponsored link or organic listing. FIG. 3 depicts a typical Google search result including an example of a user interface and search result in accordance with the prior art. It is typical for Google to return a bewildering array of more than 6 million results 300. The “organic” results 310 are on the left and the “sponsored links” 320 are on the top left and on the right. Ninety-eight percent of Google's revenue comes from these sponsored links 320. Thousands of search engine marketing (SEM) companies help advertisers position themselves close to the top of organic 310 and sponsored search results 320 to increase the likelihood of being noticed by a prospective buyer.

A permissive search intent registry system or method of the present invention provides participating merchants with an invaluable benefit because each electronic network search linked to a purchase intention may be affirmatively confirmed by the user actively looking for a product or service, as opposed to merchants inferring a user's purchase intent from amassed or collected circumstantial data. These qualified leads are much more valuable than clicks on organic or sponsored links because such searches contain the specific features and key words disclosed by an intending purchaser relative to their purchase intention. These leads take the guesswork out of locating interested buyers by merchants and may significantly reduce marketing and/or advertising costs while simultaneously improving the efficiency or productivity of marketing or advertising campaigns. Such a system or method of the present invention may award an intending purchaser at least one credit for affirmatively confirming their purchase intention and providing an estimated purchase timeline. The present invention still further enables participating merchants to offer personalized rewards or incentives to intending purchasers in return for their affirmative confirmation of their purchase intention and/or consumer interaction with displayed merchant information within an electronic network. Such interaction may include but is not limited to clicking or otherwise selecting any merchant designated content or information such as but not limited to advertisements, business information, text, HTML links, surveys, and the like that may be displayed to the intending purchaser over the electronic network.

The present invention may also give participating merchants new proactive tools. The present system or method that links intending purchasers with participating merchants in exchange for at least one credit and/or at least one reward may be bi-directional in nature, so as to also permit participating merchants to locate the intending purchasers. This unique process may not only permit participating merchants to find intending purchasers via the electronic network searches based on common criteria and/or correlated key words, but the persistent nature of the inventive system or method may permit participating merchants to immediately find intending purchasers when new searches are entered or old aggregated searches are modified. With such a unique new tool, participating merchants are no longer dependent on passively waiting for intending purchasers to locate them.

Moreover, the present invention eliminates the need to collect irrelevant information and therefore requires fewer resources to operate. It may also introduce new revenue models and reduce the dependency on sponsored links and the resulting exposure to click fraud.

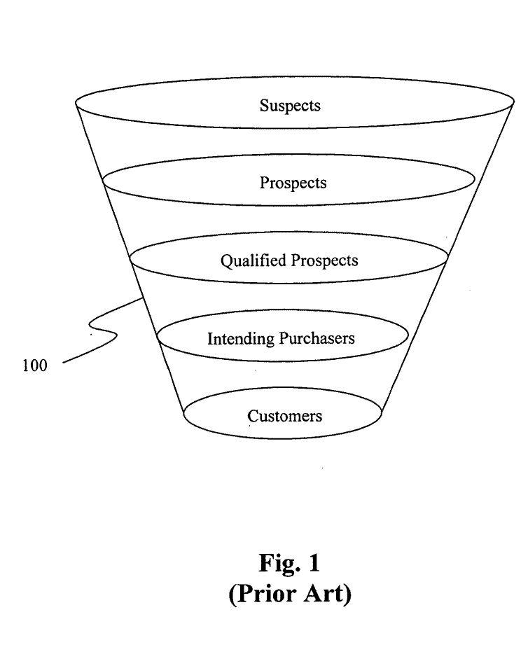

The present invention provides a system and method for generating intending purchaser leads—leads for people with a stated and/or likely intention of purchasing a particular product or service within an estimated purchase timeline. The intending purchaser leads may then be used as targets of diversified direct marketing campaigns. The present invention considers two of the categories included in the sales funnel 100 of FIG. 1. First, intending purchasers are located-people having a purchase intent within an estimated purchase timeline. In the present invention, intending purchasers may be separated from a larger pool of qualified prospects via an affirmative indication or confirmation from the intending purchasers regarding their upcoming purchase intent and/or estimated purchase timeline regarding a product or service. While all of the qualified prospects may be intending purchasers, it is much more likely that the list of prospects will be further narrowed to identify self-confirmed intending purchasers. The specifics of the implementation of the invention differ depending on the particular domain of application. However, the basic principles of the invention may be applied to any domain by recognizing appropriate affirmative confirmations made by each respective sales prospect to further identify themselves as an intending purchaser relative to each domain.

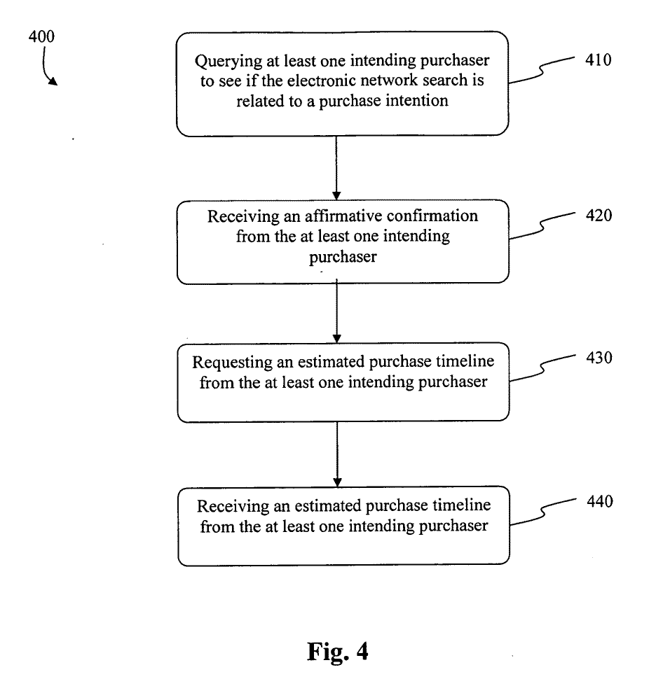

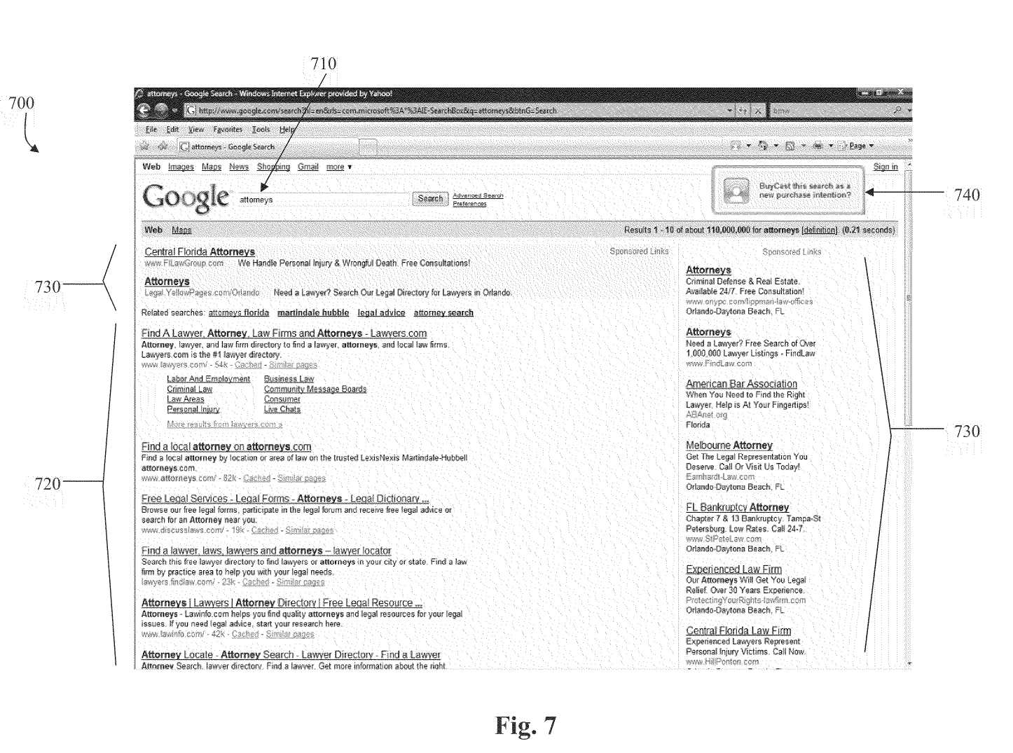

One embodiment 400 of the present invention is shown in FIG. 4 depicting a flow chart of method steps that may occur within an electronic network, such as the Internet or a television network. While the present invention may occur within any electronic network such as a distributed computer system, the Internet is preferable, because it is a publicly accessible network allowing for a much larger pool of sales prospects from which intending purchasers may be identified. In particular, the Internet provides continuous access to any prospect having an ISP connection, wherein the connection may be wired (e.g. Ethernet, DSL, cable modem, and the like) or wireless (e.g. satellite, WiFi, GSM, PCS, and the like). The method or system of the present invention may comprise a browser plug-in that may be downloaded by each respective sales prospect to assist in their normal search activities on an electronic network, such as any major search engine or shopping site. When a sales prospect initiates an electronic network search comprising at least one keyword search term, such as at any major search engine or website, the browser plug-in of the present invention may automatically launch and query 410 the sales prospect if they would like to “tag” or register their search as being related to an upcoming purchase intention via an affirmative confirmation 420 made within the electronic network (see FIG. 7), thus redefining the sales prospect as an intending purchaser.

Such an affirmative confirmation 420 may be made via intending purchaser input into the electronic network. The input may take any form known within the art including but not limited to clicking on an image displayed within a web page, clicking on one or more response options displayed over the electronic network, clicking on an image within a television commercial or digital video, using a cellular phone, PDA, or similar device to scan the bar code or unit identification code of a product, and the like. Such activities allow an intending purchaser to “tag” a product, category of products, or electronic network as being related to a purchase intention.

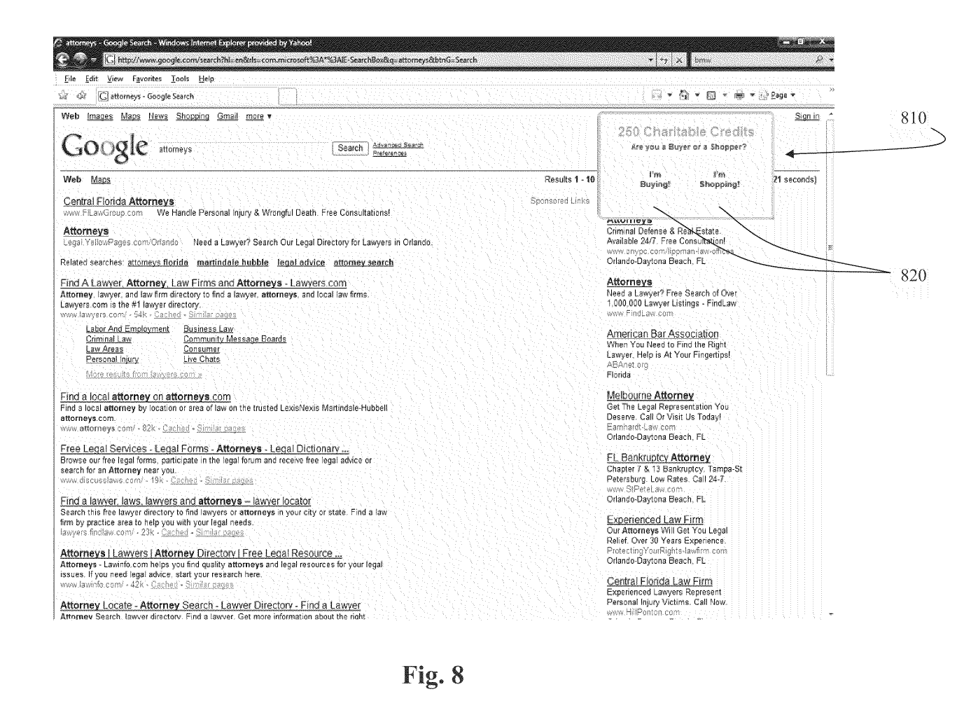

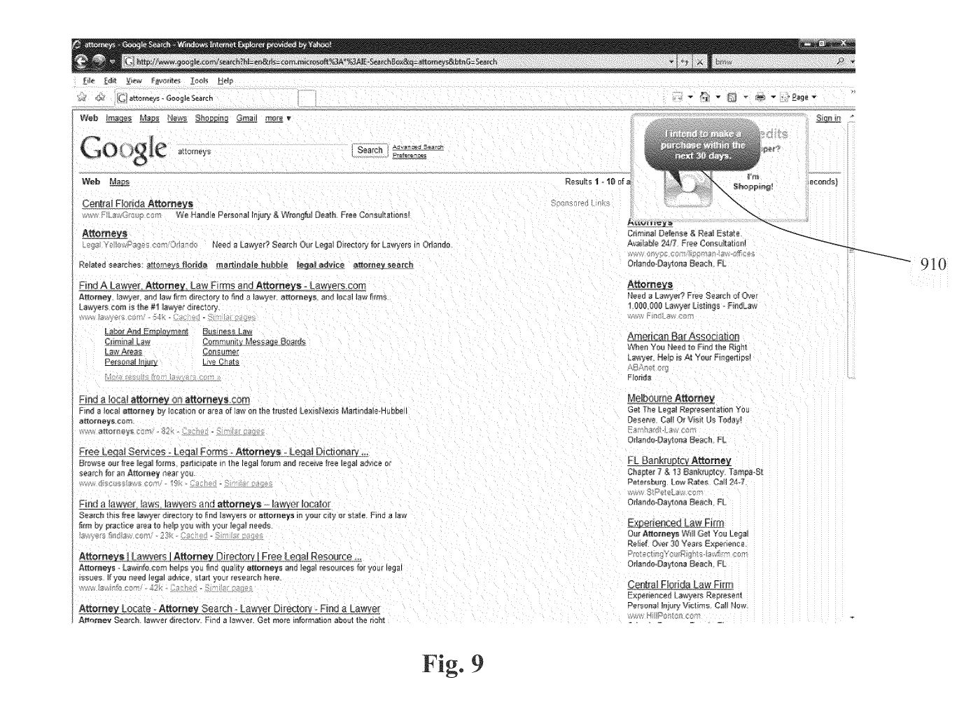

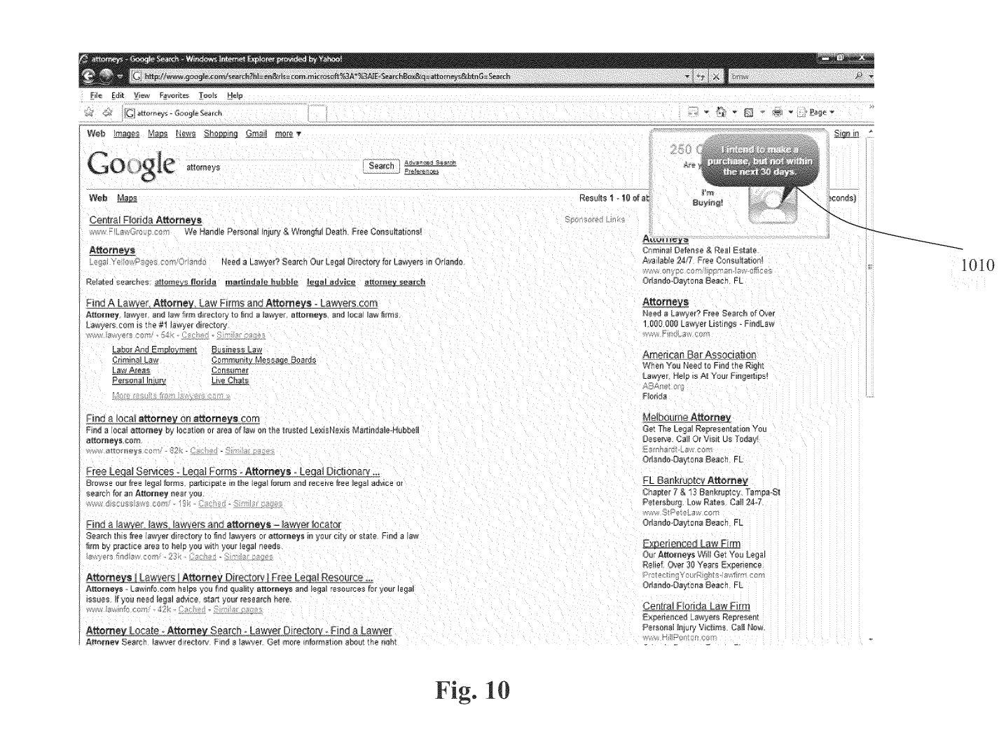

Such an affirmative confirmation 420 step may be further augmented by requesting 430 and thereafter receiving 440 an estimated purchase timeline from the at least one intending purchaser to ascertain the level of purchase intent regarding the subject matter of the electronic network search (see FIG. 8). The estimated purchase timeline may be input into a text form field within the electronic network, selected from two or more possible time frame options, and the like. The duration of the estimated purchase timeline may be defined in hours, days, weeks, months, or any other conventional time unit known within the art. In a preferred embodiment, the request 430 step may inquire if the estimated purchase timeline is within either a period of thirty days or less (see FIG. 9) or a period greater than thirty days (see FIG. 10). Such requests 430 for estimated purchase timelines may be freely customizable wherein answer options may provide for any desired periods or increments of time and the disclosed thirty day threshold is merely an illustrative example of a preferred embodiment of the present invention. The estimated purchase timeline inputted or selected by the intending purchaser may then be received 440 via the electronic network. One or more of such affirmatively confirmed active purchase intentions may be stored for future use and/or review by the intending purchaser and such purchase intentions may also be broadcast to at least one participating merchant. Such broadcasting or updating of purchase intentions allows participating merchants to compete for the business of the intending purchaser by offering special offers, incentives, discounts, and promotions to the intending purchaser.

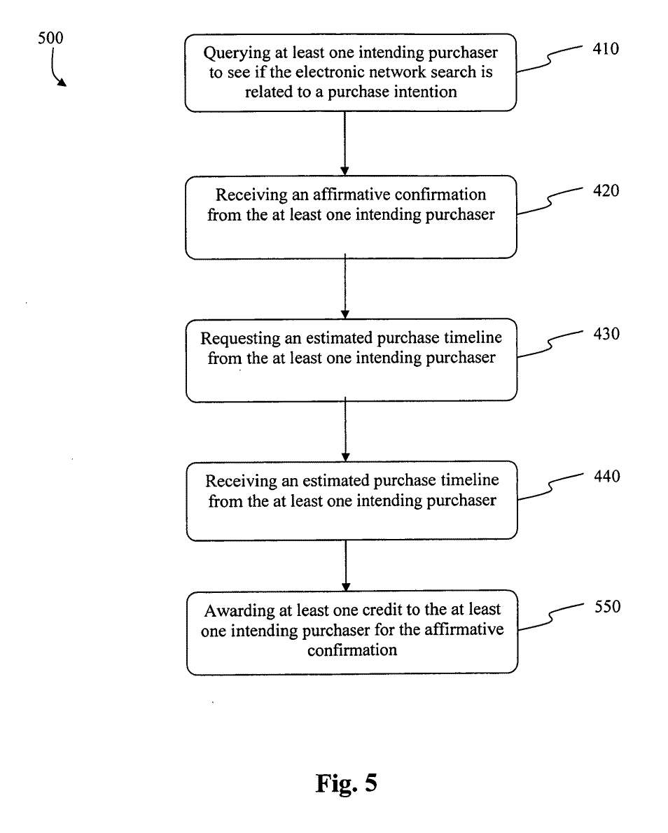

FIG. 5 depicts another embodiment 500 of the present invention wherein additional steps may be included along with those steps disclosed above and depicted in FIG. 4. The intending purchaser may further be awarded 550 at least one credit for the affirmative confirmation 420 and/or estimated purchase timeline 440 (see FIG. 8). The at least one credit may comprise a unit redeemable for a variety of options including but not limited to cash payment to the intending purchaser, merchandise credit for future purchases, charitable donations, and the like. In a preferred embodiment, the at least one credit is redeemable as a charitable contribution to a variety of entities including but not limited to charities, faith-based organizations, non-profit organizations, political action groups, advocacy groups, universities, colleges, high schools, sororities, fraternities, and the like.

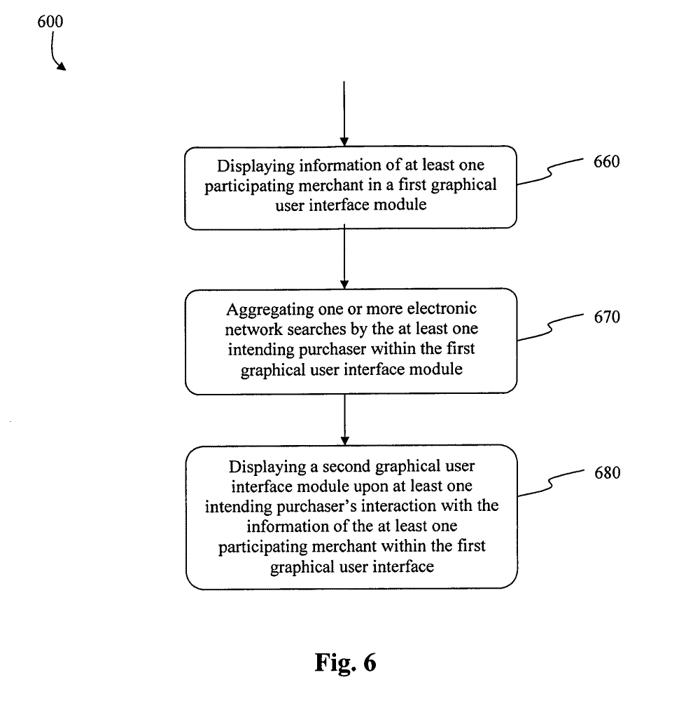

FIG. 6 depicts still another embodiment 600 of the present invention wherein additional steps may be included along with those steps disclosed above and depicted in FIGS. 4-5. The embodiment 600 of FIG. 6 may further comprise the additional steps of: displaying 660 information of at least one participating merchant in a first graphical user interface module, aggregating 670 one or more electronic network searches by the at least one intending purchaser within the first graphical user interface module; and displaying 680 a second graphical user interface module upon at least one intending purchaser's interaction with the information of at least one participating merchant within the first graphical user interface.

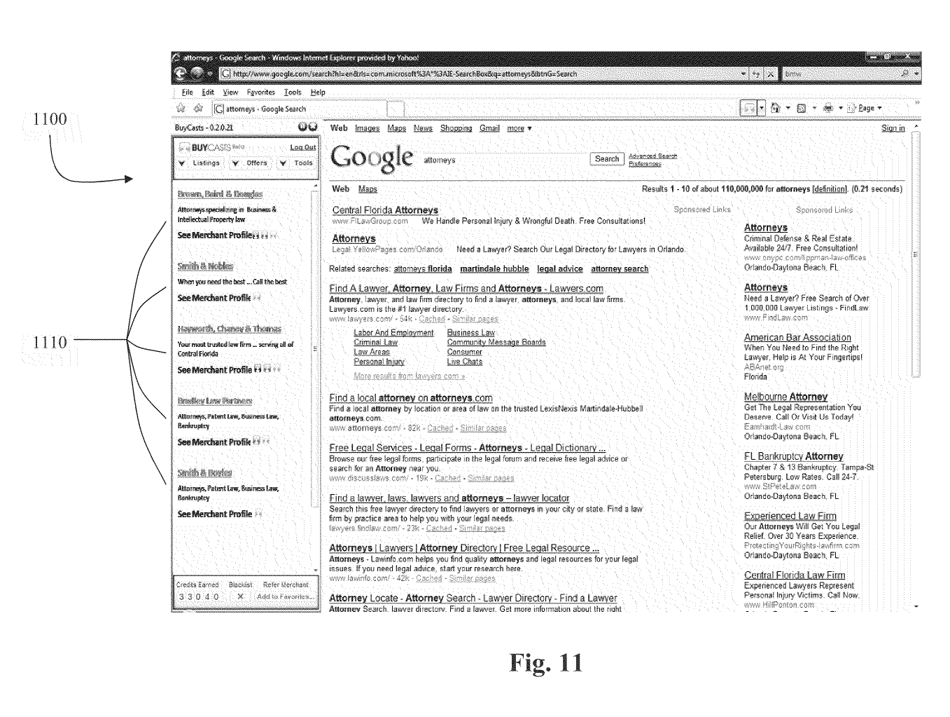

After either receipt of an affirmative confirmation 420 and/or receipt of an estimated purchase timeline 440, information may be displayed 660 in a first graphical user interface module regarding at least one participating merchant having products or services relevant to the electronic network search (see FIG. 11). The intending purchaser may further be offered at least one reward by at least one participating merchant for the intending purchaser's interaction with the displayed information of the at least one participating merchant thereby allowing participating merchants to more efficiently direct marketing and incentive campaigns to the intending purchasers having the highest probability of becoming actual purchasers. In this manner, intending purchasers may benefit by receiving special offers, discounts, promotions, and the like regarding a product, category of products, or at least one key word search term associated with their purchase intention. The affirmatively confirmed purchase intention of the intending purchaser may be broadcast to a network of participating merchants to allow the merchants to compete for the business of the intending purchasers, to the financial benefit of the intending purchaser.

The system and method of the present invention may further aggregate 670 one or more electronic network searches affirmatively confirmed as purchase intentions by the at least one intending purchaser, thereby allowing the at least one intending purchaser to easily revisit previous purchase intentions and/or rewards offered the intending purchaser by one or more participating merchants. Intending purchasers may also subsequently return to a previous purchase intentions to revise and/or amend the at least one key word search term, selected image, selected television commercial or digital video, or scanned bar code. Participating merchants may receive any such updates and/or alerts as to revisions made to a previously broadcast purchase intention. In this manner, intending purchasers may feel more relaxed and not pressured in that the intending purchaser may have a predetermined period of time to contemplate their purchases as well as rewards, incentives, and other offers received from participating merchants.

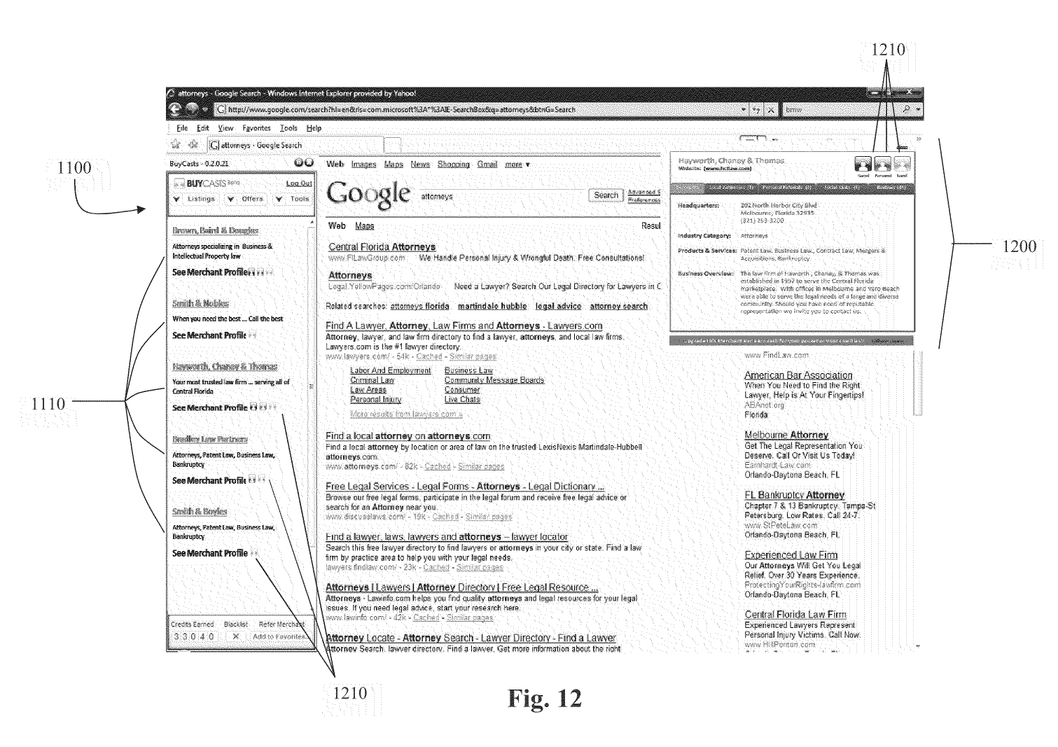

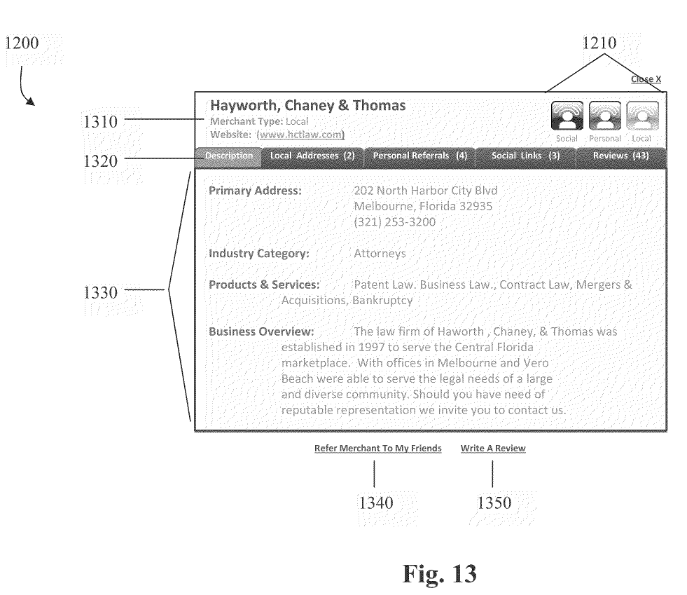

The system and method of the present invention may still further display 680 a second graphical user interface module upon at least one intending purchaser's interaction with the information of the at least one participating merchant within the first graphical user interface (see FIG. 12; and magnified views in FIGS. 13-17). Such intending purchaser interaction may include but is not limited to clicking or otherwise selecting one or more pieces of information displayed by a participating merchant. Such merchant information may comprise but is not limited to advertisements, specified merchant content, business information, at least one web address, at least one HTML link, at least one postal address, and at least one telephone number, and the like.

Illustrative examples of screen shots of preferred embodiments of the present inventive system and method are depicted in FIGS. 7-17.

FIG. 7 depicts a screen shot of one embodiment of a possible first step for a system or method of the present invention. FIG. 7 illustrates a search results page 700 returned from an electronic network search 710 for “attorneys” performed from the GOOGLE web site. Typically, such a search results page 700 comprises organic results 720 on the left and sponsored links 730 on the top left and right border. Merchants pay top dollar to have their business link and/or information appear near the top of the organic results 720 or sponsored results 730 since intending purchasers rarely look beyond the first page of search results 700. A system or method of the present invention may query the sales prospect to determine if the electronic network search 710 is related to a purchase intention, and if so, the prospect may then be redefined as an intending purchaser. In on embodiment, the query may function as a general “on/off” indicator 740, inquire if the prospect has a purchase intention regarding the electronic network search 710, and be displayed on any available user display interface known within the art, such as a computer monitor. The indicator 740 may be toggled between an on and off status based on the prospect's/intending purchaser's indicated search intention entered by the user clicking directly on the on/off indicator 740 or any relevant icons, radio buttons, and the like. Affirmative confirmation via user interaction with the indicator 740 may award at least one credit to the intending purchaser and additional incentives and/or rewards may be provided in response to subsequent intending purchaser interaction with displayed participating merchant information relevant to the initial electronic network search.

FIG. 8 depicts a screen shot for another step within one embodiment of a system or method of the present invention. After an intending purchaser provides an affirmative confirmation that the search 710 is related to a purchase intention, the present invention may then award 810 at least one credit to the intending purchaser and/or request 820 an estimated purchase timeline from the intending purchaser. Such a request 820 may allow an intending purchaser to select from an infinite number of responses, wherein a preferred embodiment may comprise at least two responses, as shown in FIG. 8. The at least two responses 820 may expressly designate or be defined by the estimated purchase timeline. In one embodiment, such a designated estimated purchase timeline may be ascertainable by hovering a computer system cursor over the respective response option(s) and/or clicking on the respective response option(s), as illustrated in FIGS. 9 and 10. FIG. 9 depicts a first response option 910 wherein, in a preferred embodiment, the estimated purchase timeline may be within a period of thirty days or less. FIG. 10 depicts a second response option 1010 wherein the estimated purchase timeline may be a period greater than thirty days.

As illustrated in FIG. 11, after a response option is selected by the intending purchaser, a first graphical user interface module 1100 may open on a display screen of the electronic network, wherein information 1110 pertaining to at least one participating merchant may be displayed therein. Such information 1110 may include but is not limited to advertisements, specified merchant content, business information, at least one web address, at least one HTML link, at least one postal address, and at least one telephone number, and the like. In a preferred embodiment, the displayed information 1110 may include active links, such as HTML links. The first graphical user interface module 1100 may comprise a smart client technology that may be downloaded by the intending purchaser to display alternate advertisements and content from at least one participating merchant that may have allocated a portion of their advertising fees for preferred placement within the first graphical user interface module 1100.

In use after browser plug-in installation, the on/off indicator 740 that queries the sales prospect may automatically launch anytime a sales prospect performs an electronic network search, such as typically done at any major search engine web site or online retailer web site. The on/off indicator 740 may remain in the “off” position until the sales prospect affirmatively confirms his or her purchase intention through the indicator 740, wherein the sales prospect is then redefined as an intending purchaser. The intending purchaser may indicate his or her purchase intention related to a specific electronic network search by any means known within the art, such as clicking on corresponding radio button(s), icons, and the like. Additionally, a sales prospect may simply allow the system or method of the present invention to time out if they choose not to register or “tag” their electronic network search as being related to a purchase intention. Without receipt of an affirmative confirmation from a sales prospect regarding the purchase intent of an electronic network search, the on/off indicator 740 may automatically fade away after a preselected period of time and assume that the electronic network search is unrelated to a purchase intention and leave the on/off indicator 740 in the “off” position. If the sales prospect affirmatively confirms a purchase intention related to the electronic network search through the on/off indicator 740, the indicator 740 may then change to the “on” position indicating that the sales prospect intends to make a purchase related to this specific search (i.e. sales prospect now redefined as an intending purchaser). After an affirmative confirmation is received from the intending purchaser, the on/off indicator 740 may fade away and the first graphical user interface module 1100 may be launched and displayed to the intending purchaser.

Information 1110 such as advertisements, specific merchant content, and the like pertaining to the electronic network search of the intending purchaser may be displayed in the first graphical user interface module 1100. The at least one participating merchant may offer at least one reward or any other known incentive to entice the intending purchaser to interact with such information 1110 and/or other content displayed within the first graphical user interface module 1100. Additionally, keyword(s) used by the intending purchaser in the electronic network search may be stored in a network device of the present inventive system. If an intending purchaser visits web site that is relevant to the stored at least one key word search term, then the first graphical user interface module 1100 may launch and display content from the site owner that is specifically targeted to the intending purchaser. Examples of such content may include but is not limited to advertisement, special offers, rewards, incentives, discounts, and the like.

A network device of a system of the present invention may comprise a personal computer running an Internet browser application, a digital cable box, and the like. Such a network device may further comprise a modem, a network interface card, or other interface devices known within the art, such as those used for coupling to Ethernet, token ring, or other types of physical and/or wireless communicative attachment means for purposes of providing a communication link to support a local or wide area network. In any event, in this manner, the network device may be coupled to a number of clients and/or servers via a conventional network infrastructure, such as a company's Intranet and/or the Internet, for example. In one embodiment, the present invention may further comprise a cookie that allows at least one additional network system to access the at least one key word search term of the electronic network search of the intending purchaser, wherein the at least one additional network may alter at least one advertisement displayed thereon to correlate with the goods or the services pertaining to the electronic network search of the intending purchaser.

As shown in FIG. 12, when an intending purchaser interacts with the displayed information 1110, a second graphical user interface module 1200 may be displayed to the intending purchaser via the electronic network. The second graphical user interface module 1200 may depict information specific to one participating merchant on a larger scale than that displayed in the first graphical user interface module 1100 and/or in more detailed than that displayed in the first graphical user interface module 1100.

FIG. 13 illustrates a magnified view of an embodiment of a second graphical user interface 1200 of the present invention. The second graphical user interface module 1200 may contain high level information 1310 regarding at least one participating merchant. The second graphical interface user interface 1200 may further comprise “tabs” 1320 or any other means known within the art to allow an intending purchaser to navigate through and view one or more pages of more detailed information 1330 regarding at least one participating merchant. The tabs 1320 may comprise a wide variety of headings including but not limited to an informative description, local addresses, personal referrals, social links, and submitted reviews regarding the specific participating merchant. FIG. 13 illustrates an embodiment of a “Description” tab being activated from among the row of tabs 1320 and the displaying of a page of more detailed information 1330 regarding the participating merchant to the intending purchaser via the second graphical user interface 1200. The second graphical user interface 1200 may further comprise a referral link 1340 that may allow an intending purchaser to refer the at least one participating merchant to one or more friends or acquaintances of the intending purchaser. Further, the second graphical user interface 1200 may comprise a review link 1350 that may allow an intending purchaser to post a review regarding the at least one participating merchant.

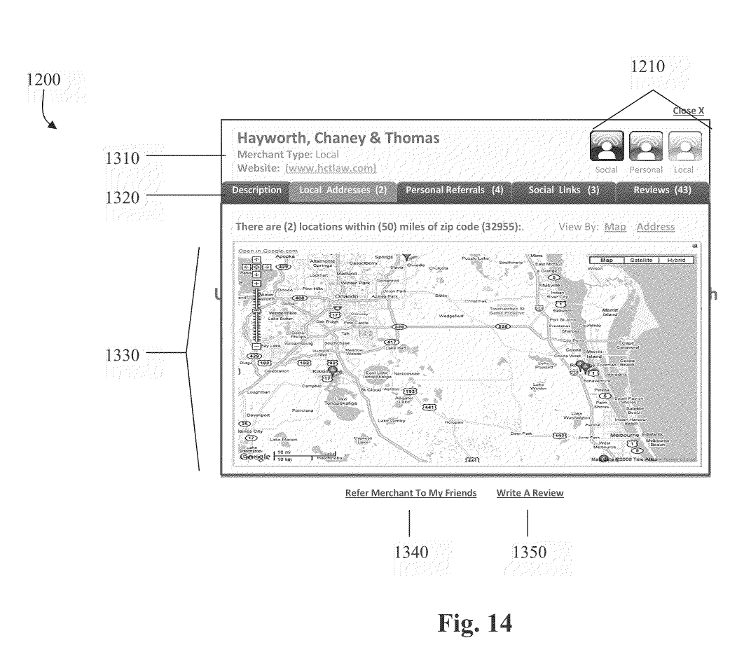

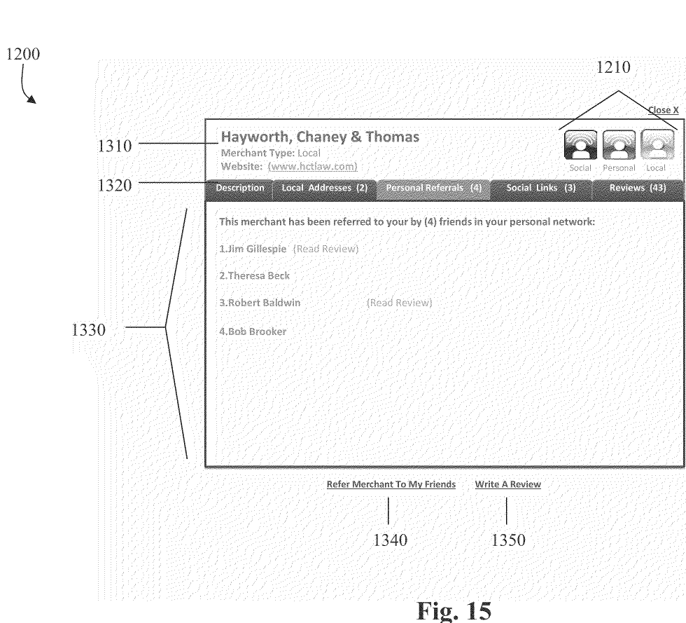

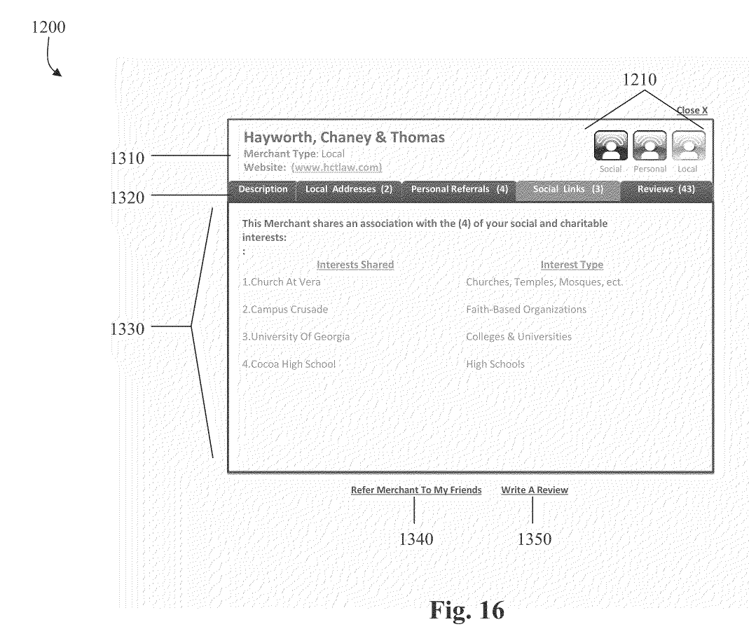

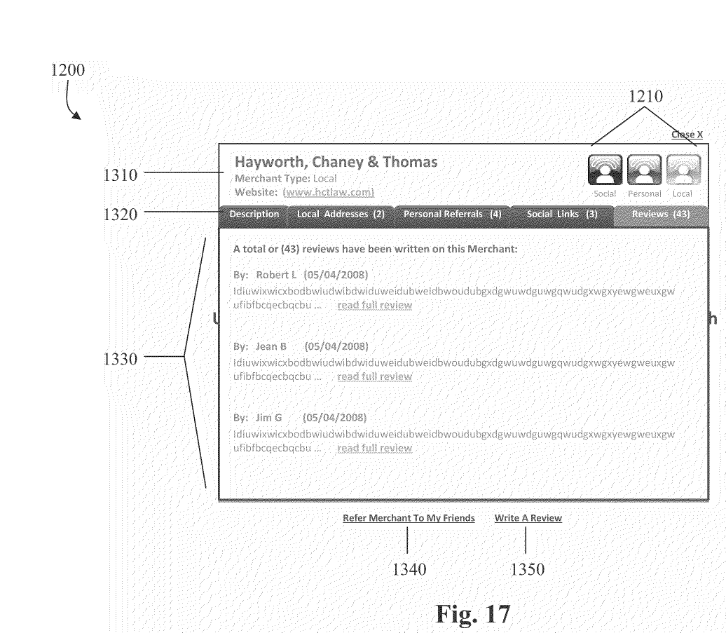

FIG. 14 generally depicts one embodiment of detailed information 1330 found under a “Local Addresses” tab 1320 of the second graphical user interface module 1200, FIG. 15 generally depicts one embodiment of detailed information 1330 found under a “Personal Referrals” tab 1320 of the second graphical user interface module 1200, FIG. 16 generally depicts one embodiment of detailed information 1330 found under a “Social Links” tab 1320 of the second graphical user interface module 1200, and FIG. 17 generally depicts one embodiment of detailed information 1330 found under a “Reviews” tab 1320 of the second graphical user interface module 1200.

Additionally, social search ranking icons 1210 may be displayed in the first graphical user interface module 1100 (see FIG. 12) and/or the second graphical user interface module 1200 (see FIGS. 12-17). Such social search ranking icons 1210 may be used by an intending purchaser to ascertain how many social contacts and or personal contacts the intending purchaser may have with a participating merchant. The social search ranking icons 1210 may further disclose the participating merchants that are local to the intending purchaser.

An embodiment of the present invention includes a system for automatically linking at least one intending purchaser with at least one participating merchant via an electronic network. Such a system may comprise at least one database accessible via the electronic network for storing at least one key word associated with products or services of the at least one participating merchant. Participating merchants may provide search terms or descriptive terms that are associated with their respective goods or services. The at least one keyword may be compared to or correlated with the search terms used in an electronic network search performed by the intending purchaser.

Another embodiment of the system of the present invention may further comprise a host server for communicating with the at least one database and with a network device via the electronic network and for executing computer-executable instructions. Such computer-executable instructions may include but are not limited to receiving at least one electronic network search input by at least one intending purchaser; in response to receiving the at least one electronic network search, querying the at least one intending purchaser to determine if the at least one electronic network search is related to a purchase intention of the at least one intending purchaser; receiving an affirmative confirmation from the at least one intending purchaser; in response to receiving the affirmative confirmation from at least one intending purchaser, awarding at least one credit to the at least one intending purchaser; requesting an estimated purchase timeline from the at least one intending purchaser; receiving an estimated purchase timeline from the at least one intending purchaser; displaying information of at least one participating merchant to the at least one intending purchaser when the electronic network search comprises at least one key word search term that correlates with the at least one key word associated with products or services of the at least one participating merchant; and offering at least one reward from the at least one participating merchant to the at least one intending purchaser for the at least one intending purchaser's interaction with the information of the at least one participating merchant.

The network device may comprise but is not limited to a personal computer running an Internet browser application, cable box capable of displaying at least one television advertisement of at least one merchant that correlates with the at least one electronic network search input by the at least one intending purchaser, and the like. While the examples disclosed mainly illustrate the method or system of the present invention being used over a network such as the Internet via a personal computer, other uses are within the scope of the invention. The present invention further encompasses the use of sharing the at least one key word search terms in an electronic network search of an intending purchaser over a wired or wireless television network to allow participating merchants to display targeted television advertisements to intending purchasers/viewers targeting the goods or services searched for in the electronic network search by the intending purchaser/viewer. Such television networks may include cable, satellite, and the like.

The at least one database accessible via the electronic network may function to store at least one reward offered by at least one participating merchant to at least one intending purchaser and/or store the at least one credit awarded to the intending purchaser for an affirmative confirmation. In this manner, an intending purchaser may not be “scared off” or made to feel pressured about making a purchaser at that moment, since the intending purchaser may recall the stored reward or incentive at a later date.

While the above description contains much specificity, these should not be construed as limitations on the scope of any embodiment, but as exemplifications of the presently preferred embodiments thereof. Many other ramifications and variations are possible within the teachings of the various embodiments. Thus the scope of the invention should be determined by the appended claims and their legal equivalents, and not merely by the examples given.

What is claimed is:

1. A method of linking at least one intending purchaser with at least one participating merchant via an electronic network, said method comprising the steps of:
querying said at least one intending purchaser to determine if an electronic network search is related to a purchase intention of said at least one intending purchaser; and
receiving an affirmative confirmation from said at least one intending purchaser that said electronic network search is related to said purchase intention of said at least one intending purchaser.

2. The method of claim 1, further comprising the steps of:
requesting an estimated purchase timeline from said at least one intending purchaser; and
receiving said estimated purchase timeline from said at least one intending purchaser.

3. The method of claim 2, further comprising the step of:
awarding at least one credit to said at least one intending purchaser in exchange for said affirmative confirmation.

4. The method of claim 1, further comprising the step of:
aggregating one or more of said electronic network searches within a first graphical user interface module allowing for subsequent review by said at least one intending purchaser.

5. The method of claim 2, wherein said estimated purchase timeline is selected from the group consisting of a period of thirty days or less and a period greater than thirty days.

6. The method of claim 1, further comprising the step of:
displaying information of said at least one participating merchant to said at least one intending purchaser via said electronic network when said electronic network search comprises at least one key word search term that correlates with at least one key word associated with products or services of said at least one participating merchant.

7. The method of claim 6, wherein said information of said at least one participating merchant is selected from the group consisting of advertisements, specified merchant content, business information, at least one web address, at least one HTML link, at least one postal address, and at least one telephone number.

8. The method of claim 6, wherein a cookie allows at least one additional network system to access said at least one key word search term of said electronic network search of said at least one intending purchaser, wherein said at least one additional network alters at least one advertisement displayed thereon to correlate with said goods or said services pertaining to said electronic network search.

9. The method of claim 1, further comprising the step:
offering at least one reward from said at least one participating merchant to said at least one intending purchaser for incentivizing said at least one intending purchaser to transact with said at least one participating merchant regarding said purchase intention.

10. The method of claim 9, wherein said at least one reward is selected from the group consisting of a special offer, a discount, a promotion, and an incentive.

11. A method of linking at least one intending purchaser with at least one participating merchant via an electronic network, said method comprising the steps of:
querying said at least one intending purchaser to determine if an electronic network search is related to a purchase intention of said at least one intending purchaser;
receiving an affirmative confirmation from said at least one intending purchaser that said electronic network search is related to said purchase intention of said at least one intending purchaser;
requesting an estimated purchase timeline from said at least one intending purchaser;
receiving said estimated purchase timeline from said at least one intending purchaser;
displaying information of said at least one participating merchant to said at least one intending purchaser via said electronic network when said electronic network search comprises at least one key word search term that correlates with at least one key word associated with products or services of said at least one participating merchant, wherein said information of said at least one participating merchant is selected from the group consisting of advertisements, specified merchant content, business information, at least one web address, at least one HTML link, at least one postal address, and at least one telephone number; and
offering at least one reward from said at least one participating merchant to said at least one intending purchaser for incentivizing said at least one intending purchaser to transact with said at least one participating merchant regarding said purchase intention.

12. A system for linking at least one intending purchaser with at least one participating merchant via an electronic network, said system comprising:
means for querying said at least one intending purchaser to determine if an electronic network search is related to a purchase intention of said at least one intending purchaser; and
means for receiving an affirmative confirmation from said at least one intending purchaser that said electronic network search is related to said purchase intention of said at least one intending purchaser.

13. The system of claim 12, further comprising:
means for requesting an estimated purchase timeline from said at least one intending purchaser; and
means for receiving said estimated purchase timeline from said at least one intending purchaser.

14. The system of claim 13, further comprising:
means for awarding at least one credit to said at least one intending purchaser in exchange for said affirmative confirmation.

15. The system of claim 12, further comprising:
means for aggregating one or more of said electronic network searches within a first graphical user interface module allowing for subsequent review by said at least one intending purchaser.

16. The system of claim 13, wherein said estimated purchase timeline is selected from the group consisting of a period of thirty days or less and a period greater than thirty days.

17. The system of claim 12, further comprising:
means for displaying information of said at least one participating merchant to said at least one intending purchaser via said electronic network when said electronic network search comprises at least one key word search term that correlates with at least one key word associated with products or services of said at least one participating merchant, wherein said information of said at least one participating merchant is selected from the group consisting of advertisements, specified merchant content, business information, at least one web address, at least one HTML link, at least one postal address, and at least one telephone number.

18. The system of claim 17, further comprising:
means for allowing at least one additional network system to access said at least one key word search term of said electronic network search of said at least one intending purchaser, wherein said at least one additional network alters at least one advertisement displayed thereon to correlate with said goods or said services pertaining to said electronic network search.

19. The system of claim 12, further comprising:
means for offering at least one reward from said at least one participating merchant to said at least one intending purchaser for incentivizing said at least one intending purchaser to transact with said at least one participating merchant regarding said purchase intention.

20. The system of claim 19, wherein said at least one reward is selected from the group consisting of a special offer, a discount, a promotion, and an incentive.
